(19) United States
(12) Patent Application Publication
(10) Pub. No.: US 2025/0155279 A1
(43) Pub. Date: May 15, 2025

(54) NANOCATENANE STRUCTURE AND NANOMACHINE INCLUDING NANOCATENANE STRUCTURE

(71) Applicant: SEOUL NATIONAL UNIVERSITY R&DB FOUNDATION, Seoul (KR)

(72) Inventors: Jwa-Min NAM, Seoul (KR); Yoonhee KIM, Seoul (KR)

(73) Assignee: SEOUL NATIONAL UNIVERSITY R&DB FOUNDATION, Seoul (KR)

(21) Appl. No.: 18/838,251

(22) PCT Filed: Aug. 1, 2023
(86) PCT No.: PCT/KR2023/095034

§ 371 Date: Aug. 14, 2024

(30) Foreign Application Priority Data
Aug. 4, 2022 (KR) 10-2022-0097408

(51) Int. Cl. G01J 1/02; B82Y 15/00; B82Y 20/00

(52) U.S. Cl. CPC G01J 1/02; B82Y 15/00; B82Y 20/00

(57) ABSTRACT

Provided according to an embodiment of the present subject matter is a nanocatenane structure including at least two chained ring structures, each structure consisting of a core and a shell covering the core, wherein the chained ring structures are chemically coupled in a joining area.

### TECHNICAL FIELD

### Cross-Reference to Related Application

This application claims priority to and the benefit of Korean Patent Application No. 10-2022-0097408 filed in the Korean Intellectual Property Office on Aug. 4, 2022, the entire contents of which are incorporated herein by reference.

### Technical Field

The present invention relates to a nanocatenane structured body and a nanomachine comprising a nanocatenane structure.

### Background Art

A manipulation of light-matter interactions based on a plasmonic nanostructure has attracted considerable interest over the past two decades. Numerous assembled geometries of plasmonic nanostructures have been proposed to achieve a system with unique properties such as plasmonic coupling, optical magnetism, and chirality, beyond controlling the optical properties of individual nanoparticles. Since these unique optical responses originate from their specific geometries, molecular similarities that share similar optical properties often provide insight into the design of plasmonic nanostructures. For example, an artificial magnetism in a plasmonic nanodisk heptamer system evokes a ring current generated by delocalized γ-electrons in an aromatic molecule in response to an external magnetic field. In addition, an axial chiral geometry of a non-naphthyl derivative and a twisted plasmonic nanorod dimer has a general optical fiber response to circular polarization.

In particular, in case of an assembled nanosystem with excellent optical properties, it is difficult to maintain an assembled structure under various conditions. Apart from a structure built from a top-down structure, this difficulty is mainly due to the presence of a functional molecule, which is a significant constituent element in building a specific geometric structure. To overcome these inherent limitations and improve optical properties, unbreakable coupling between the constituent nanostructures is required. In addition, mechanically coupled plasmonic nanostructures may provide nanomachines that are capable of using structural operations and plasmonic properties and functions, such as cantenanes.

### DISCLOSURE

### Technical Problem

The present invention is directed to providing a method of manufacturing a nanocatenane structured body with high selectivity.

In addition, the present invention is directed to providing a nanocatenane structured body exhibiting chirality, and to providing a novel nanomachine using the same.

### Technical Solution

According to an embodiment of the present invention, there is provided a nanocatenane structured body comprising at least two interlocked ring structured bodies, in which the ring structured body comprises a core and a shell that covers the core, and in which the interlocked ring structured bodies are chemically bonded at a joining region.

According to an embodiment of the present invention, there is provided the nanocatenane structured body, in which the core comprises a metal or a semiconductor material.

According to an embodiment of the present invention, there is provided the nanocatenane structured body, in which at least some regions of a ring inner surface of the ring structured body are modified with at least one of DNA, a protein, or a ligand, and in which a joining region of the interlocked ring structured body is provided with a cross-linking molecule generated by the binding of at least one of the DNA, protein, or ligand.

According to an embodiment of the present invention, there is provided the nanocatenane structured body, in which a ring outer surface of the ring structured body has a structure modified with a compound comprising a thiol group.

According to an embodiment of the present invention, there is provided the nanocatenane structured body, in which the ring structured bodies have an interlocked structure with the ring structured bodies spaced apart from each other by a distance of 20 to 100 nm.

According to an embodiment of the present invention, there is provided the nanocatenane structured body, in which the ring structured bodies are interlocked with each other in a tilted form.

According to an embodiment of the present invention, there is provided a method of synthesizing a nanocatenane structured body, the method comprises: a first step of preparing a core; a second step of preparing a modified core by modifying the core with at least one of DNA, protein, and ligand; a third step of reacting at least two of the modified cores to be interlocked; and a fourth step of growing a metal on the interlocked core to close a missing region of the modified core.

According to an embodiment of the present invention, there is provided the method of synthesizing a nanocatenane structured body, in which the first step comprises: step 1-1 of preparing a nanoplate; step 1-2 of growing the core along an edge of the nanoplate; and step 1-3 of preparing the core by etching the nanoplate.

According to an embodiment of the present invention, there is provided the method of synthesizing a nanocatenane structured body, in which a surface of the core is modified with a compound comprising a thiol group between step 1-2 and step 1-3.

According to an embodiment of the present invention, there is provided the method of synthesizing a nanocatenane structured body, in which the third step comprises forming a chemical bond by reacting at least one of DNA, a protein, or a ligand provided on a ring outer surface of the modified core.

According to an embodiment of the present invention, there is provided the method of synthesizing a nanocatenane structured body, in which the nanocatenane structured body converts a linear force into a rotational mechanical motion by a light-induced thermal operation, in which the nanocatenane structured body comprises at least two interlocked ring structured bodies, in which the ring structured body comprises a core and a shell configured to cover the core, and in which the interlocked ring structured bodies are chemically bonded at a joining region.

According to an embodiment of the present invention, there is provided a nanomachine, in which the nanocatenane structured body controls a circular dichroism (CD) of a nanostructure.

### Advantageous Effects

According to an embodiment of the present invention, a nanocatenane structured body exhibiting chirality can be manufactured.

In addition, according to an embodiment of the present invention, a nanocatenane structured body of a catenane structure can be synthesized with high selectivity.

### DESCRIPTION OF DRAWINGS

FIG. 1 is a flowchart schematically illustrating a method of synthesizing a nanocatenane structured body according to an embodiment of the present invention.

FIG. 2 is results of analyzing properties of a precursor for synthesizing the nanocatenane structured body according to an embodiment of the present invention.

FIG. 3 illustrates a selective modified form of a Pt core (a Pt split nanoring; PtSNR) according to an embodiment of the present invention.

FIG. 4 is results of analyzing properties of the nanocatenane structured body according to an embodiment of the present invention.

FIG. 5 is electron microscope observation images of the nanocatenane structured body with various thicknesses according to an embodiment of the present invention.

FIG. 6 is SEM images of the nanocatenane structured body according to an embodiment of the present invention.

FIG. 7 is results of analyzing SEM and dark-field images according to an embodiment of the present invention.

FIG. 8 is results of analyzing a correlation between an optical response and a structural form of the nanocatenane structured body according to an embodiment of the present invention.

FIG. 9 is results of analyzing a gap distance according to LSPR of the nanocatenane structured body according to an embodiment of the present invention.

FIG. 10 is results of analyzing chirality of the nanocatenane structured body according to an embodiment of the present invention.

FIG. 11 is results of analyzing an asymmetric optical response of the nanocatenane structured body according to an embodiment of the present invention under circularly polarized light.

FIG. 12 is results of analyzing a light-induced thermal operation of a plasmonic nanomachine that is mechanically interoperated.

FIG. 13 is results of analyzing a light-induced thermal operation of a PNIPAM modified (M)-nanocatenane structured body.

### BEST MODE FOR DISCLOSURE

The present invention may be variously modified and may have various forms, and particular embodiments illustrated in the drawings will be described in detail herein. However, the description of the exemplary embodiments is not intended to limit the present invention to the particular exemplary embodiments, but it should be understood that the present invention is to cover all modifications, equivalents and alternatives falling within the spirit and technical scope of the present invention.

In the description of the drawings, similar reference numerals are used for similar constituent elements. In the accompanying drawings, the dimensions of the structures are illustrated at larger scale for clarity of the present invention. The terms such as “first” and “second” may be used to describe various constituent elements, but the constituent elements should not be limited by the terms. These terms are used only to distinguish one constituent element from another constituent element. For example, a first component may be named a second component, and similarly, the second component may also be named the first component, without departing from the scope of the present invention. Singular expressions comprise plural expressions unless clearly described as different meanings in the context.

In the present application, the terms “comprises,” “comprising,” “comprises,” “comprising,” “containing,” “has,” “having” or other variations thereof are inclusive and therefore specify the presence of stated features, integers, steps, operations, elements, components, and/or combinations thereof, but do not preclude the presence or addition of one or more other features, integers, steps, operations, elements, components, and/or combinations thereof. In addition, when one component such as a layer, a film, a region, or a plate is described as being positioned “on” another component, one component can be positioned “directly on” another component, and one component can also be positioned on another component with other components interposed therebetween. In addition, in the present specification, when one component such as a layer, a film, a region, or a plate is described as being formed on another component, the direction in which one component is formed is not limited to an upward direction and comprises being formed in a lateral or downward direction. On the contrary, when one component such as a layer, a film, a region, or a plate is described as being positioned “under” another component, one component can be positioned “directly under” another component, and one component can also be positioned on another component with other components interposed therebetween.

In the present specification, the terms “upper surface” and “lower surface” are used as relative concepts to describe the technical ideas of the present invention for ease of understanding. Therefore, the terms “upper surface” and “lower surface” do not refer to a specific orientation, position, or constituent element and can be used interchangeably. For example, “upper surface” can be interpreted as “lower surface” and “lower surface” can be interpreted as “upper surface”. Therefore, “upper surface” can be expressed as “first” and “lower surface” as “second”, or “lower surface” can be expressed as “first” and “upper surface” can be expressed as “second”. However, in one embodiment, the terms “upper surface” and “lower surface” are not interchangeable.

The present invention relates to a nanocatenane structured body having a catenane structure, which is a mechanically interoperated molecular structure, a method of synthesizing the same, and an application thereof.

The nanocatenane structured body of the present invention may be synthesized from a triangular metal nanoplasmonic structured body. In a nanocatenane structured body consisting of two rings in terms of D2d spatial symmetry, one nanoring may cause a dissymmetry in terms of D2 symmetry compared to the other nanoring, thereby leading to high g-factor chiroptical responses. The nanocatenane structured body with these features may be applied as a nanomachine, such as a nanoactuator, in which a light-induced thermal operation of a plasmonic nanomachine may control the circular dichroism (CD) of the plasmonic nanostructure by converting a linear force into a rotational mechanical motion.

The nanocatenane structured body according to the present invention comprises at least two interlocked ring structured bodies, in which the ring structured body comprises a core and a shell that covers the core, and in which the interlocked ring structured bodies are chemically bonded at a joining region.

In this case, a ring structured body means a ring, which may have the form of a circle, an ellipse, a square, a rhombus, etc. in the plane. The form of the ring structured body is not restricted as long as it is a closed loop. Further, the two ring structured bodies provided in the catenane structured body may have the same shape as each other or may have different shapes. For example, when the two ring structured bodies are interlocked, the shape and size of the two ring structured bodies may be the same. Alternatively, one ring may have the shape of a circle and the other ring may have the shape of an ellipse, and the sizes of the rings may be different. A specific form of the ring structured body may vary depending on a use of the nanocatenane structured body, electrical and optical properties desired to be achieved, etc.

The ring structured body may comprise a core and a shell that covers the core. The core may be provided corresponding to the form of the ring structured body. For example, the core may be provided in the form of a split ring. The split ring has the form of a ring but has an open loop structure, meaning that part of the ring is missing. Since the split ring has an open loop structure, the two split rings may be engaged in an interlocked structure.

The core of the ring structured body may comprise at least one material selected from the group consisting of metals such as gold (Au), silver (Ag), palladium (Pd), and platinum (Pt), or semiconductor materials. For example, the core may use a material that provides a growth site for the synthesis of an Au shell on a surface thereof. In addition, the core may use a material with a different etch reactivity than a material that consists of a nanoplate. This enables selective etching of only the nanoplate among the nanoplate and core when the core is prepared by synthesizing the core on an edge of the nanoplate and etching the nanoplate in a core preparation process as described below. For example, the nanoplate may be composed of gold (Au) and the core may use a material that has a different etch reactivity than gold (Au).

The shell that covers the core of the ring structured body may be provided along the surface of the core. The shell is provided in the form that specifically covers a missing region of the core. Therefore, when the shell is provided, the ring structured body exhibits a closed loop structure with no missing region. Therefore, at least a portion of the shell may be provided in a region where the core is absent, and the shell may cover the core to form an interlocked structure of the ring structured body. The shell, like the core, may comprise metals such as gold (Au), silver (Ag), palladium (Pd), and platinum (Pt), or semiconductor materials. The core and the shell may be composed of the same material or different materials.

In this case, in order to provide an interlocked structure of the ring structured body, that is, a structure in which at least two interlocked ring structured bodies are joined, the interlocked ring structured bodies may be chemically bonded at a joining region adjacent to each other. In this case, the joining region of the ring structured bodies may mean a region where the two ring structured bodies are most adjacent, rather than a region where the shells provided for each ring structured body physically come into contact.

The ring structured bodies adjacent to each other in the joining region described above may be chemically bonded by cross-linking molecules. Specifically, at least some regions of the ring structured body may be modified with a carboxyl compound and an amine compound, in which the carboxyl compound and amine compound on two cores adjacent to each other may be bound such that two ring structured bodies are chemically bonded.

In order to provide a chemical reaction by the cross-linking molecules in the joining region, a ring inner surface and a ring outer surface of the core may be modified respectively.

First, the ring outer surface may be modified with a material that is less reactive with the cross-linking molecule. For example, the ring outer surface may be modified with a compound comprising a thiol group. They have low reactivity with the carboxyl compound, amine compound, or other thiol groups. Therefore, when these materials are introduced to the ring outer surface for modification in a subsequent process, there is no concern that the ring outer surface will binds to DNA, proteins, or other chemical ligands provided on the ring inner surface, or that the ring outer surface will be modified by the carboxyl compound or the amine compound. Accordingly, the ring outer surface modified with a compound comprising the thiol group has no chance of participating in the interlocked structure of the core. Therefore, only the ring inner surfaces may chemically be bonded to each other, thereby creating a stable interlocked structure. For example, the ring outer surface may be modified with polyethylene glycol methyl ether thiol (PEG methyl ether thiol).

The ring inner surface may be modified with DNA, proteins, or other chemical ligands. For example, the ring inner surface may be modified with a carboxyl compound or an amine compound. For example, when a first ring structured body and a second ring structured body are interlocked, an inner surface of a core comprised in the first ring structured body may be modified with a carboxyl group and an inner surface of a ring of a core comprised in the second ring structured body may be modified with an amine group. That is, when the two ring structured bodies are interlocked, each of the cores comprised in the two interlocked ring structured bodies may be modified with a different type of material.

When a carboxylic compound is provided on the ring inner surface, the carboxylic compound may be a linear compound comprising a carboxyl group at one end thereof and a thiol group at the other end thereof. In this case, the thiol group may bind to the core, and the carboxyl group may bind to the amine group provided on the other core in the joining region during a subsequent interlocking process. The carboxyl compound may also be a linear polymer compound, and a gap between the two ring structured bodies at the joining region may be adjusted when the ring structured bodies are interlocked by adjusting a chain length of the carboxyl compound.

Similarly, when an amine compound is provided on the ring inner surface, the amine compound may be a linear compound comprising an amine group at one end thereof and a thiol group at the other end thereof. In this case, the thiol group may bind to the core, and the amine group may bind to the carboxyl group provided on the other core in the joining region during a subsequent interlocking process. The amine compound may also be a linear polymer compound, and a gap between the two ring structured bodies at the joining region may be adjusted when the ring structured bodies are interlocked by adjusting a chain length of the amine compound.

The ring structured bodies may have an interlocked structure in a state where they are spaced apart from each other by a distance of 20 to 100 nm. When the distance (gap) between the ring structured bodies is in the range described above, there is an advantage in that the interlocked structure may be synthesized without fusion between the two ring structured bodies during a subsequent process of synthesizing the shell.

Ring structured bodies may be interlocked in a tilted form with each other. A tilted angle between the ring structured bodies may mean, for the two ring structured bodies, an angle formed by a plane comprising both a “center of the ring” and a “ring” of each ring. As the ring structured bodies are provided in the form of tilted to each other, the interlocked nanocatenane structured bodies have a chirality.

With these functions of the catenane structure, it is possible to implement a light-induced thermally operated nanomachine using a thermoresponsive poly(N-isopropylacrylamide) (PNIPAM) that mimics a vibrating motion of one ring in the catenane structure. Beyond a low critical solution temperature (LCST) of the PNIPAM, a surface of AuNCat modified with the PNIPAM becomes hydrophobic as the PNIPAM shrinks. Sequentially, adjacent nanorings are attracted to each other, increasing an asymmetric angle of the AuNCat. These structural conversions cause a change in the spectrum, comprising plasmon scattering and CD.

Therefore, the nanocatenane structured body with chirality may convert a linear force into rotational mechanical motion by a light-induced thermal operation. Further, the nanocatenane structured body may be implemented in the form of a nanomachine to control the circular dichroism (CD) of the nanostructure using the chirality and motion conversion functions described above.

Next, a method of synthesizing a nanocatenane structured body will be described.

A method of synthesizing a nanocatenane structured body according to the present invention comprises a first step of preparing a core; a second step of preparing a modified core by modifying the core with at least one of DNA, protein, and ligand; a third step of reacting at least two of the modified cores to be interlocked; and a fourth step of growing a metal on the interlocked core to close a missing region of the modified core.

The first step is a step to prepare the core. The core may be prepared according to a synthesis process comprising step 1-1 of preparing a nanoplate; step 1-2 of growing the core along an edge of the nanoplate; and step 1-3 of preparing the core by etching the nanoplate.

The nanoplate used in step 1-1 may be a gold nanoplate that has the form of a triangle in the plane. The gold nanoplate described above are suitable to grow the core selectively at the edge portion and subsequently manufacture the core, which is a split ring in the form of an open loop after gold etching.

In step 1-2, the core is grown in the shape of a ring along the edge of the gold nanoplate. The core is selectively grown at the edge of the gold nanoplate, and the core may be substantially not grown on an upper surface and a lower surface of the gold nanoplate. In this case, the core may be a split ring structure in the form of an open loop with some regions missing.

In step 1-3, the gold nanoplate may be etched away, leaving only the core provided at the edge of the gold nanoplate. The gold nanoplate may be etched using a solution that selectively etches gold among the gold and metal forming the core. Therefore, only the gold nanoplate may be selectively etched by immersing the gold nanoplate and core in the solution described above.

After performing step 1-2 and before performing step 1-3, the surface of the core may be modified with a compound comprising a thiol group. The compound comprising the thiol group is provided in the form that covers the entire core provided on the gold nanoplate and the edge thereof. In this case, an inner surface of the core ring is attached to the gold nanoplate, and thus is not modified with the compound comprising the thiol group.

Then, when selective etching with the compound comprising the thiol group is performed in step 1-3, the gold nanoplate may be removed and a core may be provided in which only an outer surface of the core ring has been modified with the compound comprising the thiol group (“modified core”).

Next, the second step of preparing the modified core is performed by modifying the core with at least one of DNA, protein, or ligand. The second step is a step of modifying the core with at least one of DNA, protein, or ligand, in which the ring inner surface of the core is selectively modified. The ring outer surface of the core is not modified by at least one of the DNA, a protein, or a ligand in the second step because the ring outer surface is modified with the compound comprising the thiol group as described above.

In the second step, the inner surface of the core may be modified only by a carboxyl compound and/or an amine compound. For example, the modified cores may be divided into two types: a type in which the inner surface is modified with the carboxyl compound and a type in which the inner surface is modified with the amine compound. As described above, the cores modified with different compounds may complementarily are bound together on the modified ring inner surfaces to form an interlocked structure.

In the third step, the modified cores are reacted and interlocked. As described above, the carboxyl-modified core, which is modified by the carboxyl compound and comprises the carboxyl group, and the amine-modified core, which is modified by the amine compound and comprises the amine group, may be complementarily bound by a condensation reaction of the carboxyl group and the amine group. Therefore, the two cores are connected by a chemical bond. A material that may be used as the carboxyl compound comprises an alkane compound, and a material that may be used as the amine compound comprises an azide compound.

In the fourth step, a metal or a semiconductor is grown on the interlocked core to close the missing region of the modified core. In the fourth step, a metal precursor material (metal ion solution) or semiconductor precursor material for metal or semiconductor growth may be reacted with the core to complete the nanocatenane structure.

As described above, the nanocatenane structured body, the method of synthesizing the nanocatenane structured body, and the nanomachine comprising the nanocatenane structured body of the present invention have been described.

Hereafter, the present invention will be described in more detail through practical experimental examples.

### Mode for Disclosure

In the experimental example, gold (Au) was used as a metal to synthesize a metal catenane structured body.

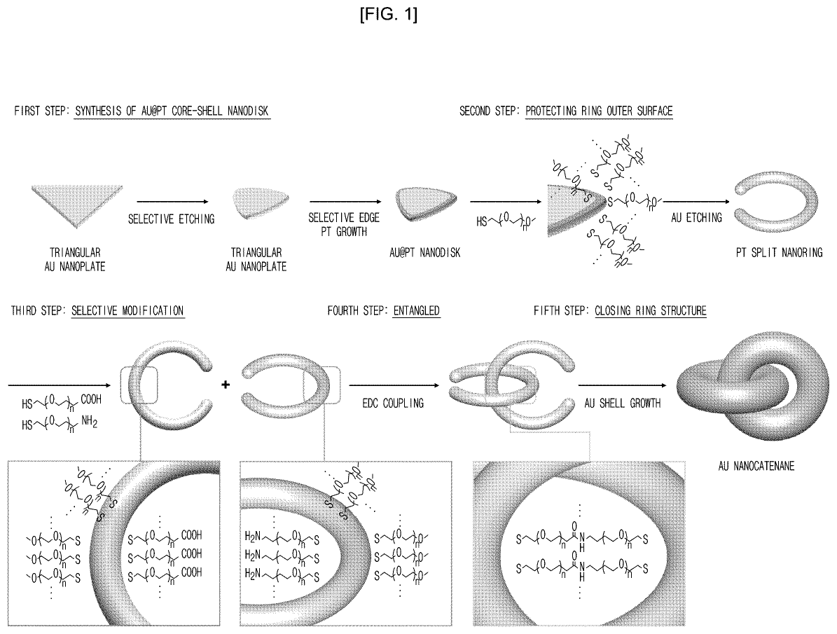

As can be seen in the drawings, in the present invention, starting from a triangular Au nanoplate, a mechanically interlocked gold nanocatenane structured body (AuNCats) consisting of two gold nanorings assembled through mechanical coupling while preserving plasmonic coupling was synthesized (FIG. 1).

FIG. 1 is a flowchart schematically illustrating a method of synthesizing a nanocatenane structured body according to an embodiment of the present invention.

In a metal-templated synthesis of the AuNCat, molecules with the shapes of a ring and a crescent are prepared as precursors. These precursors have coordination platforms that are capable of forming metal-ligand complexes and come together with copper ions to create entangled forms. Next, by closing the molecule in the shape of a crescent, the two molecules are connected by a mechanical coupling.

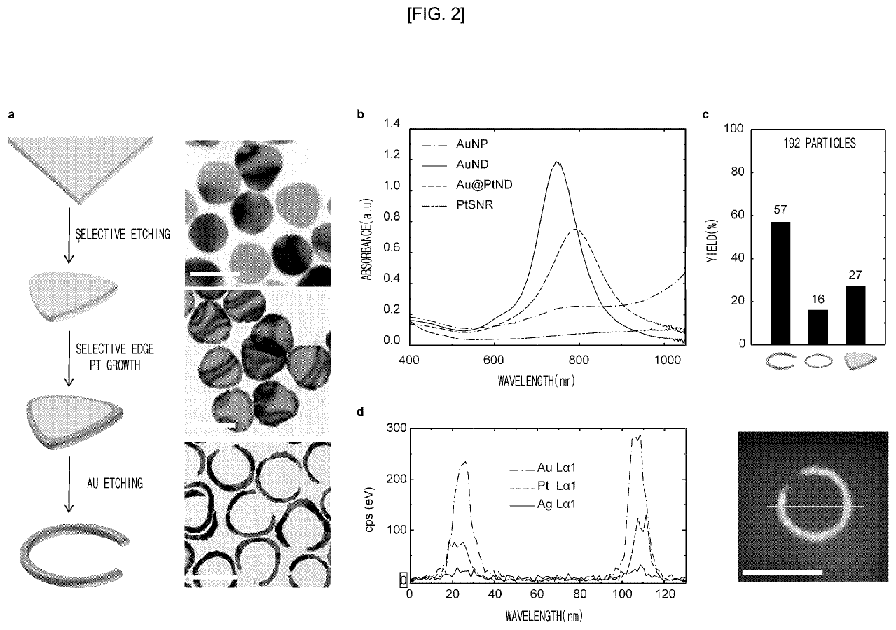

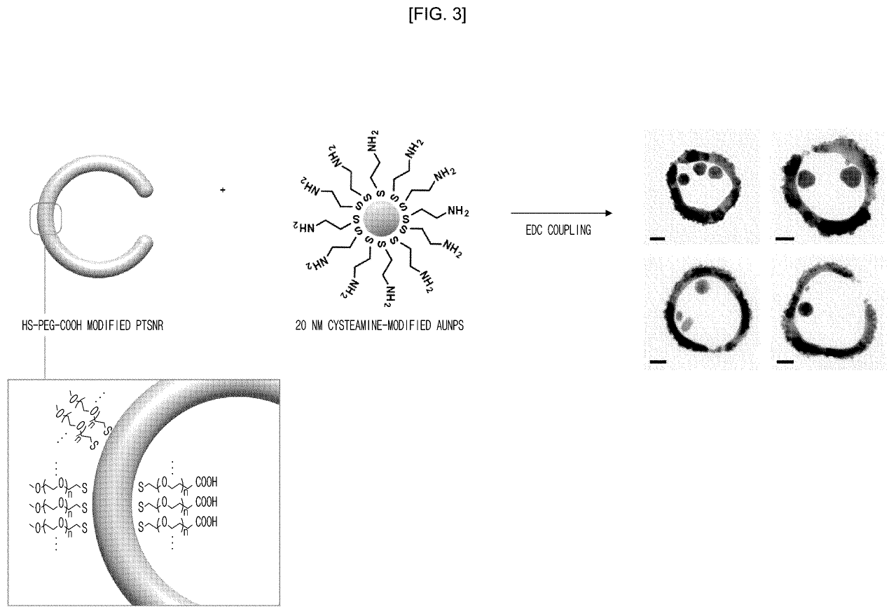

Similarly, in the synthesis of the AuNCats, the core (Pt split nanoring (PtSNR)) is first manufactured as a precursor nanoparticle of an Au@Pt core-shell nanodisk. The Au@Pt nanodisk is synthesized from a triangular Au nanoplate and then Pt is selectively grown at an edge region (see FIG. 2). Before etching an Au portion to obtain the Pt split nanoring, an outer surface of a Pt frame is chemically protected by polyethylene glycol (PEG) methyl ether thiol. Then, the Au etching leads to the Pt split nanoring with an exposed interior and a protected exterior, which may selectively modify an inner surface of the split nanoring precursor. Next, PEG 2-mercaptoethyl ether acetic acid and PEG 2-mercaptoethyl ether ethylamine selectively modify the inner surface of the Pt split nanoring. Here, approximately 17 nm of carboxylic acid and amine-terminated PEG are used to obtain a linker of approximately 35 nm, which ensures a suitable interparticle distance. The selective modifiability and ability to protect an outer surface of methoxy PEG was confirmed by the chemical linkage between the selectively modified Pt-split nanoring and small spherical nanoparticles (see FIG. 3). After preparing the precursor, the Pt split nanorings selectively modified with the carboxylic acid and amine group are connected by forming an amide bond through EDC/sulfo-NHS (EDC; N-(3-Dimethylaminopropyl)-N′-ethylcarbodiimide hydrochloride) bond, which provides a suitable entangled form for interlocking. Finally, Au growth on the assembled Pt split nanorings may close the split ring structure to obtain the mechanically interlocked AuNCat from the two nanorings.

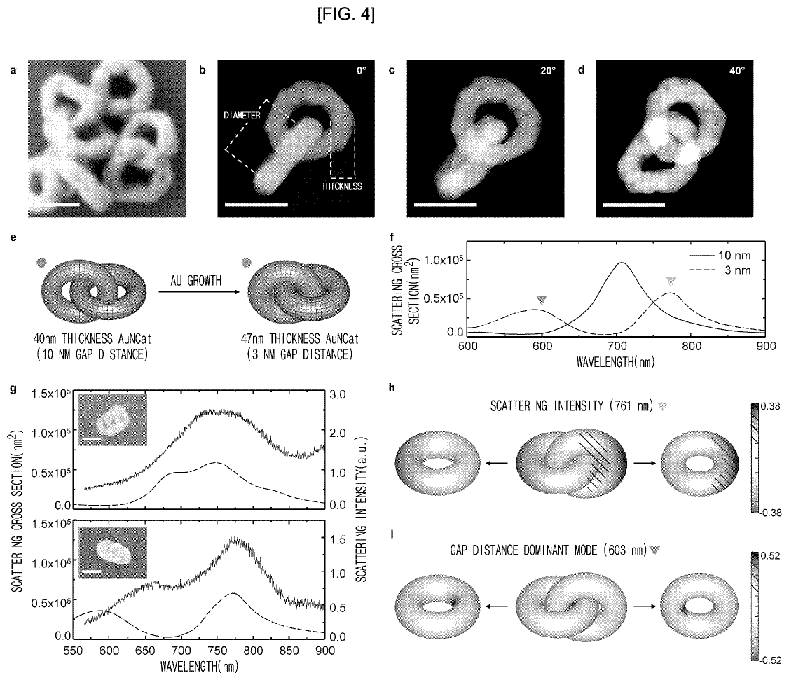

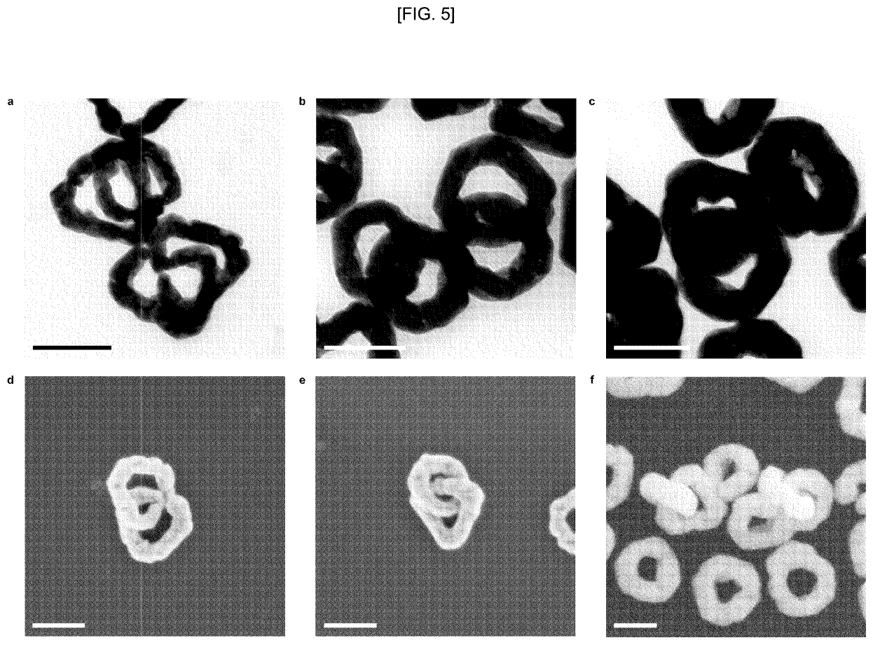

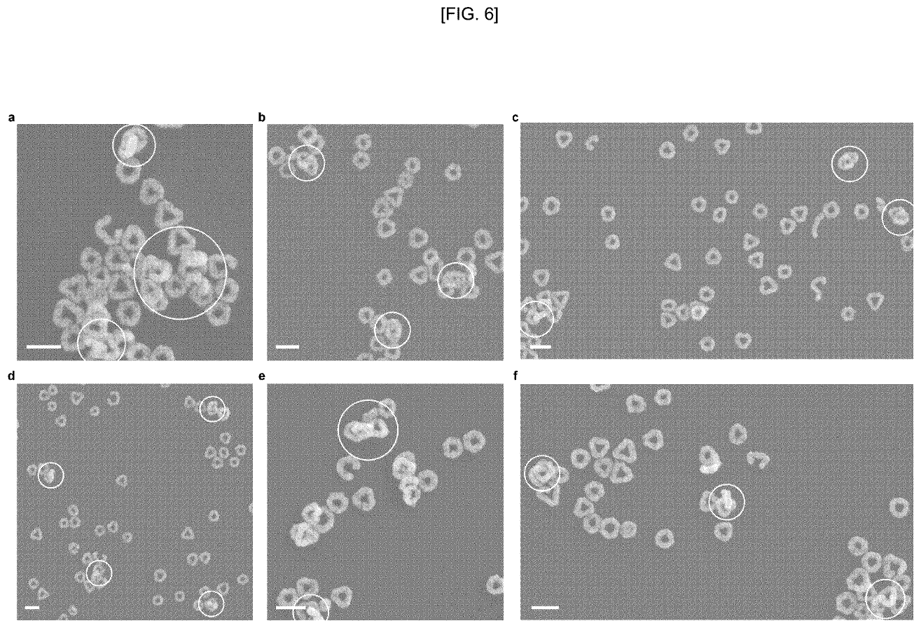

The structure of the synthesized AuNCat was confirmed by an electron microscope. The scanning electron microscope (SEM) image (FIG. 4A) clearly illustrates that the two Au nanorings are mechanically coupled together. In addition, it was confirmed that the two nanorings of AuNCat do not merge during Au growth by using HAADF-STEM electron microscopy at different tilt angles (FIGS. 4B to 4D). A thickness (minor diameter) of the synthesized AuNCat can vary from 25.0±3.7 nm to 44.4±4.6 nm depending on the amount of HAuCl4 added during the Au growth step (see FIG. 4E and FIG. 5). Meanwhile, a diameter (major diameter) of the AuNCat is maintained relatively constant from 91.2±14.6 nm to 97.6±14.4 nm, which is because the dimensions of the Pt-split nanoring precursor are preferentially determined. A final yield of AuNCat was approximately 8% without optimization, which was limited by many factors, comprising a yield of the Pt-split nanoring, efficiency of EDC/sulfo-NHS bonding, effective particle mixing, and collisions (see FIG. 6).

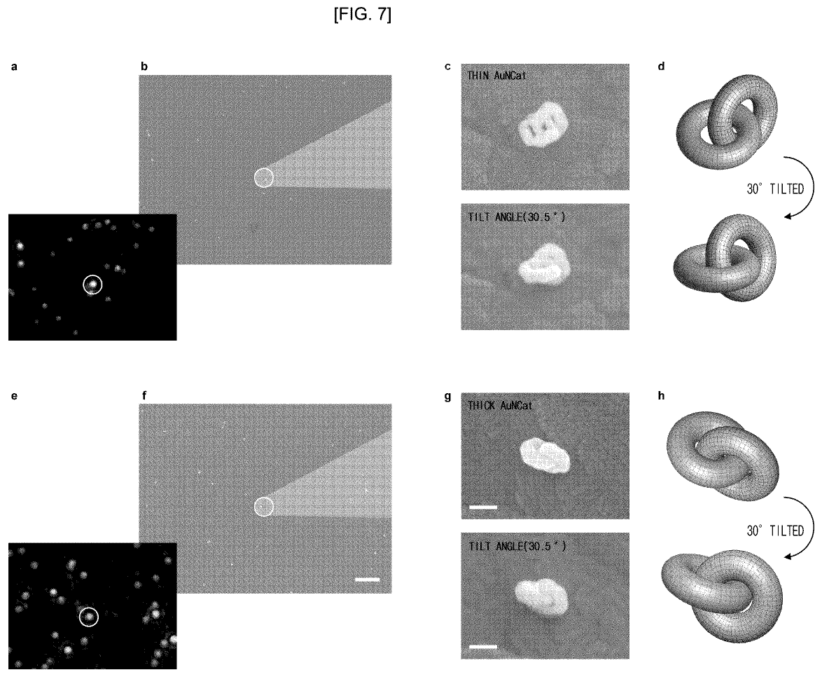

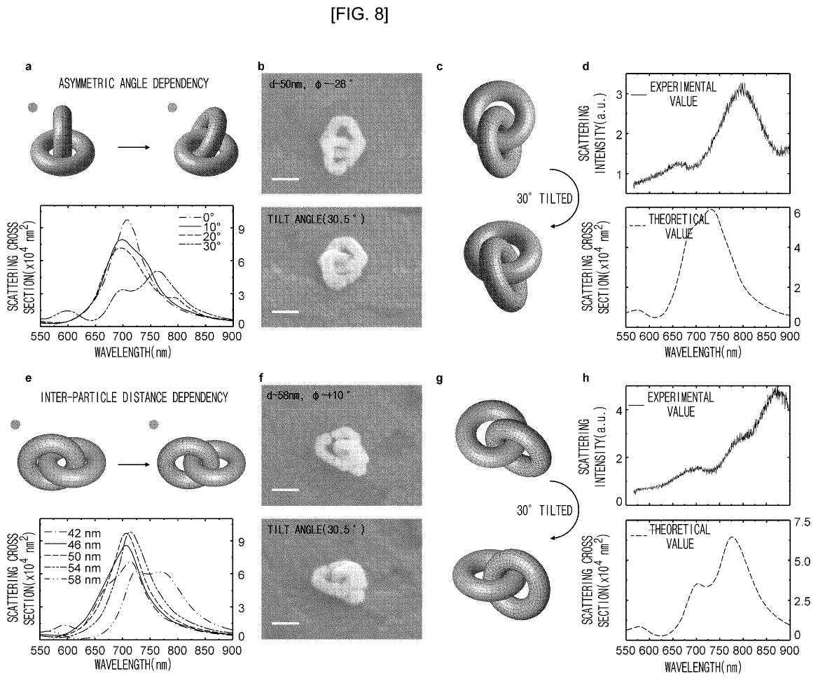

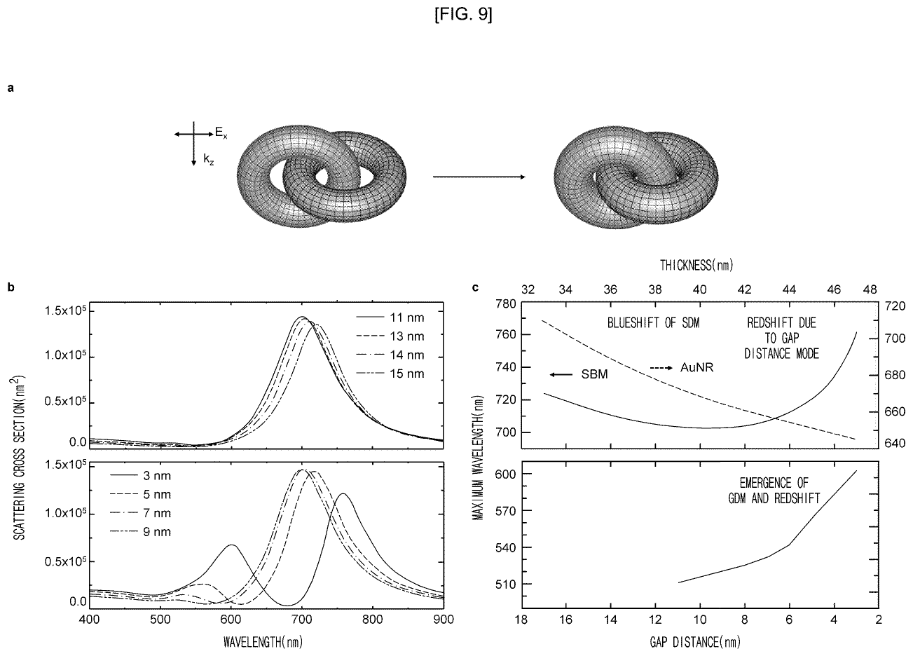

To clearly analyze an optical response of individual AuNCats with precise structure and configuration, dark-field scattering spectra associated with SEM were measured at a single-particle level (see FIG. 4G and FIG. 7). In addition, the boundary element method (BEM) was used to numerically solve the Maxwell's equations and calculate a scattering cross section for the configuration shown in the Insertion image of FIG. 4G, which is consistent with the experimental scattering spectrum. The measured scattering spectra are distinguished by several variables, such as an interparticle distance and an asymmetric angle (see FIG. 8). A notable difference with the thickness (minor diameter) is the presence of spectral asymmetry for the thicker AuNCat (FIG. 4F). As the gap distance decreases and the thickness increases, asymmetric features appear. To quantify when asymmetry appears, first, the theoretical resonance frequency of the LSP mode of the AuNCat while increasing the thickness is examined (FIG. 4E). Increasing the thickness generally results in a blueshift of the symmetric dipole mode of the Aunanorings, but when the gap distance is smaller than 9 nm, the LSP resonance starts to become a redshift and splits into two modes with spectral distortion (see FIG. 9). The asymmetry of the spectrum and the presence of convergence for the scattering-free cross section between these two resonance frequencies may be considered an indication of destructive interference between the emergent LSPs (FIG. 4F).

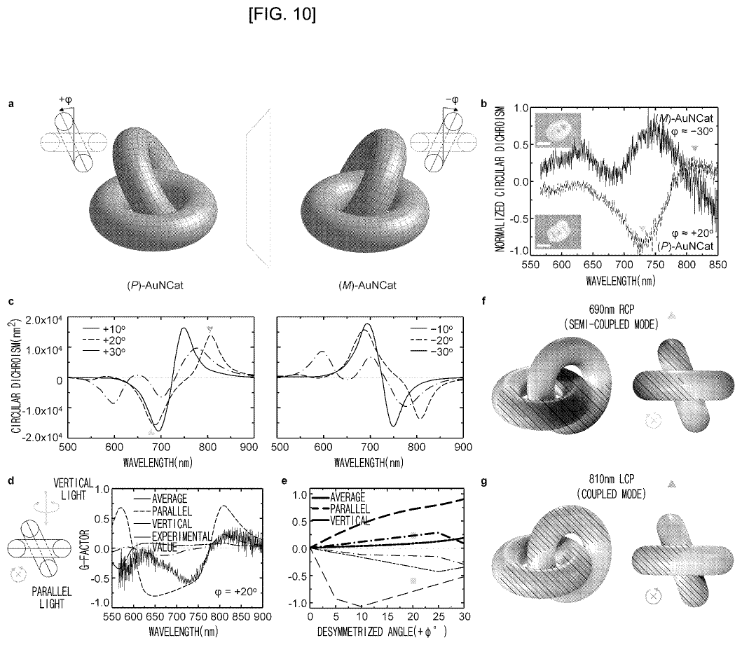

The AuNCats have chirality in structure. Basically, D2d symmetric AuNCats do not exhibit chirality. However, the vibrating motion of one nanoring relative to the other nanoring causes desymmetrization from the D2 group, and the deviation from 0° of the desymmetrization angle provides the mechanical helical chirality. According to the definition of the desymmetrization angle (FIG. 10A), the positive sign of the dihedral angle indicates (P)-AuNCat, while the negative sign indicates (M)-AuNCat (FIG. 10A), which follows the nomenclature of mechanical helicity in the catenane. Therefore, each AuNCat has its own chirality. Therefore, (P)- and (M)-AuNCats exhibit different optical responses under circularly polarized light, and the resulting CDs of the scattering spectra may be measured according to the dark-field illumination setup (FIG. 10B).

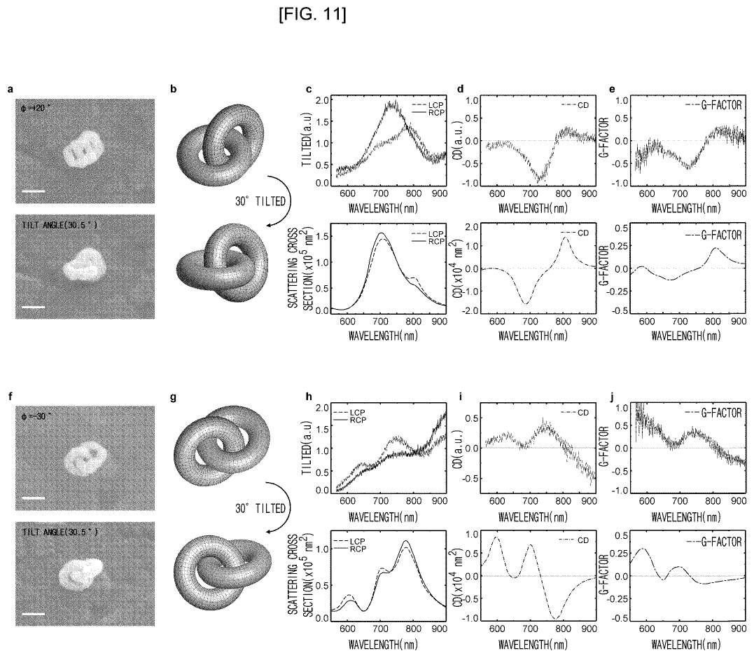

Similarly, the optochiral response of the AuNCat was dependent on the desymmetrization angle (FIG. 10C). As the AuNCat is distorted from θ=0° to 15°, the relative CD intensity gradually increases and then decreases again until θ=30°. In contrast, the optical anisotropy, also known as the g-factor, increases continuously up to a theoretical maximum of 0.3, which is averaged over three orthogonal k-vectors (FIG. 10E). The experimentally obtained g-factor of the particle illustrated in FIG. 10B indicates the calculated g-factor corresponding to the desymmetrization angle (FIG. 10D and extended data in FIG. 11E and FIG. 11J). They have a tendency to have higher values than the average theoretical g-factor of the desymmetrization angle (FIG. 10D). The g-factors of the (P)- and (M)-AuNCats may reach up to a maximum of 0.3, which is a very large g-factor value compared to other single or assembled plasmonic nanostructures, which have g-factors of approximately 0.14 to 0.2. The notably high g-factor appears to result from the proximity between the centers of the two vibrational dipole modes of each nanoring, which strongly influence each other and cause a large difference in the response to LCP and RCP.

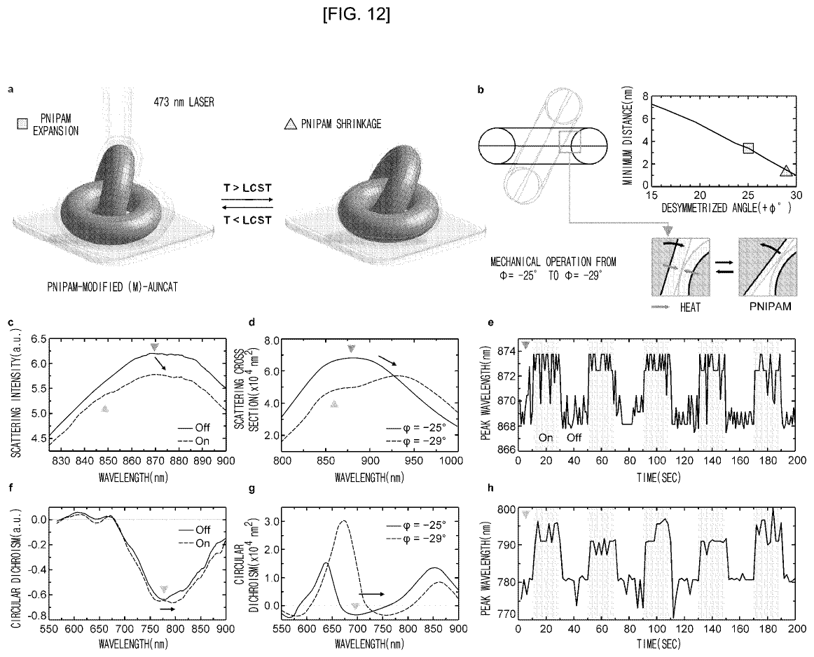

One of the features of the catenane structure is an ability to operate a mechanical motion. With these functions of the catenane structure, the light-induced thermally operated AuNCat was devised using a thermoresponsive PNIPAM (poly(N-isopropylacrylamide)) that mimics the vibrating motion of one ring in the catenane structure. Beyond a low critical solution temperature (LCST) of the PNIPAM, a surface of AuNCat modified with the PNIPAM becomes hydrophobic as the PNIPAM shrinks. Sequentially, adjacent nanorings are attracted to each other, increasing an asymmetric angle of the AuNCat (FIG. 12A). These structural conversions cause a change in the spectrum, comprising plasmon scattering and CD.

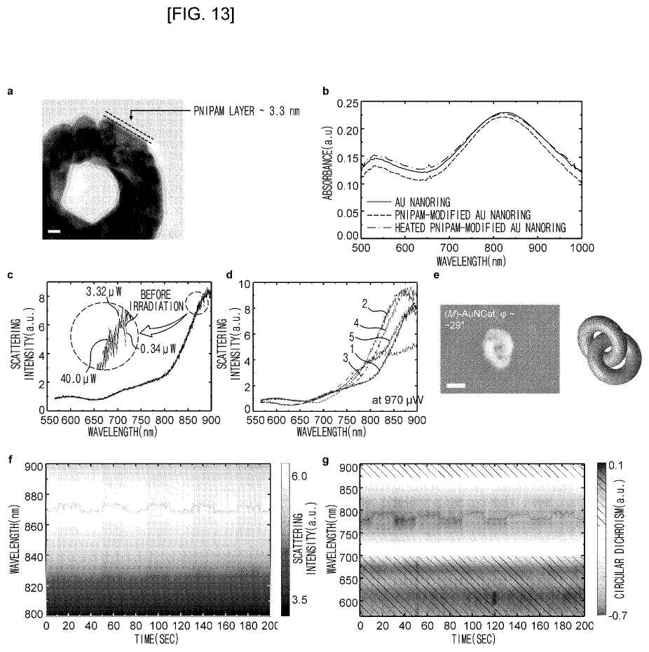

When the local temperature around the PNIPAM-modified AuNCat is increased by irradiation with a laser of 473 nm that induces interband transitions of gold, the optical heat generated by the entire AuNCat causes the PNIPAM to shrink. This specifically operates a tilted motion through the PNIPAM in the gap region on the lateral surface (FIG. 12B). A change in structure may be estimated by measuring the optical response of the AuNCat. A suitable laser power of 0.97 mW is selected because a weaker laser power is insufficient to increase a local temperature through the LCST of the PNIPAM and is unable to operate the mechanical motion (FIG. 13A). An irreversible change in spectrum occurred during an initial period of irradiation (see extended data in FIG. 13B), but after repeated irradiation cycles, the scattering response reached a reversible state of change (FIG. 12E and FIG. 12H). It can be predicted, based on the irreversibly changing spectra, that a random tilted motion of the mechanically interoperated nanoring is caused by the PNIPAM shrinkage and expansion. Then, the coated PNIPAM reaches equilibrium and a reversible change in spectrum occurs. The scattering spectra of the AuNCat in the reversible region are obtained while turning the laser on and off at an interval of 20 s under unpolarized LCP and RCP illumination, respectively (see extended data in FIG. 13D and FIG. 13E).

The scattering peak of (M)-AuNCat is redshifted from 868.2 nm to 873.8 nm when irradiated with light and returns to the original resonance frequency after the light is turned off. In addition, the intensity of the peak decreases, splitting into two peaks (FIG. 12C). This trend is consistent with a change in spectrum with an increment of the desymmetrization angle (FIG. 12D). Compared to the features of the calculated scattering cross section, it can be assumed that the irradiation results in a reversible tilted motion of the AuNCat between θ=−25° and θ=−29° (FIG. 12B). The SEM images taken after all measurements show a similar level of asymmetry (see extended data in FIG. 13C). This means that the time for heat dissipation is sufficiently faster than the time for heat gain, and heat accumulation does not affect the reversible PNIPAM expansion and shrinkage.

The degree of shift in the CD is more intense than the shift in the scattered signal. FIG. 12F illustrates the CD response processed after measuring the scattering response according to LCP and RCP separately. In this post CD, the spectral peak of the negative signal redshift is shifted by the irradiation from 779.8 nm to 792.2 nm on average. Similarly, the spectral modulation is identical to the trend seen when the desymmetrization angle increases at γ=−25° and γ=−29° (FIG. 12G). Although there are differences between experiment and calculation, mainly due to the non-identical distribution of the k vector, the general spectral behavior supports the mechanical operation of the AuNCat.

The generation of rotational motion is an essential technology to effectively control the CD response of the assembled structure. In nanoscale systems, this has only been possible with DNA origami so far. Instead, the mechanically interlocked structure exhibits a unique geometry that is capable of converting a linear force into a rotational motion. Here, considering an angle between a local force and a point of application, a torque of 0.04 aNqbq generated in the process of conversion was seen in the change in CD, which means that the AuNCat system may be used as a plasmonic nanomachine.

In the present invention, a mechanically interoperated plasmonic architecture was synthesized from a starting material of triangular nanoplate, which presents a new scheme for the total synthesis of a mechanically interlocked metal nanostructure. The strong helical chirality of AuNCats originating from the mechanical coupling and the light-induced thermal operation were also studied. The synthetic yield of AuNCats can be optimized by improving the yield of precursors, adjusting particle surface chemistry and conditions and methods of particle mixing, adopting different particle geometries, and chemical control of linkers and growth kinetics. In addition, the nanocatenane structures can be diversified by introducing different nanocomponents with different sizes, shapes, shell thicknesses, and ligands, as well as extended to higher order plasmonic[n] nanocatenane systems.

### Manufacturing Example

The gold nanocatenane structured body according to an embodiment of the present invention was synthesized by the following method.

### Synthesis of Rounded Au Nanodisk

The rounded Au nanodisk was manufactured using a three-step seed-mediated method using iodide ions. All preparations were carried out in aqueous solution with deionized water. The citric acid-coated seed solution was prepared by adding 1 mL of 10 mM HAuCl₄ and 1 mL of 10 mM trisodium citrate solution in a 50 mL round bottom flask. Then, 500 μL of ice-cold 200 mM NaBH₄ solution was quickly added. The solution was mixed with a stirring rod at 500 rpm for one minute and then aged at 27° C. for three hours to completely hydrolyze the unreacted NaBH₄.

Meanwhile, three growth solutions were prepared to obtain the triangular-shaped Au nanoplate. The first two solutions comprise 250 μL of 10 mM HAuCl₄ and 9 mL of 50 mM CTAB solution in a 25 mL glass bottle, and the last one was prepared by mixing 1.25 mL of 10 mM HAuCl₄ and 50 mM CTAB solution in a 50 mL round bottom flask. All solutions were preheated at 27° C. for 10 minutes, after which other reagents were added and the three-step growth process was carried out in a water bath at 27° C. After the aging period of the seed solution, 50 μL of 100 mM NaOH, 50 μL of 10 mM NaI, 50 μL of 100 mM ascorbic acid, and 1 mL of the citric acid-coated seed solution was sequentially added to the primary growth solution at intervals of 30 seconds. Next, after stirring at 500 rpm for 30 seconds and aging for 10 minutes, 1 mL of a solution in which 50 μL of 100 mM NaOH, 50 μL of 10 mM NaI, and 50 μL of 100 mM ascorbic acid were injected at intervals of 30 seconds is added to the secondary growth solution. The solution was stirred at 500 rpm for 30 seconds and incubated for 10 minutes. Lastly, 250 μL of 100 mM NaOH, 250 μL of 10 mM NaI, 250 μL of 100 mM ascorbic acid, and 5.2 mL of the secondary growth solution were added to the third growth solution and stirred at 700 rpm. All reagents were injected at intervals of 30 seconds. The solution was stirred for one minute and aged for one hour.

Then, the mixture obtained was transferred to a 70 ml bottle having a flat glass bottom and left in an isothermal oven at 30° C. overnight. Accordingly, the triangular-shaped Au nanoplate precipitates on the bottom. After removing the supernatant, the precipitate is redispersed in 20 mL of DIW to synthesize the rounded triangular Au nanoplate through an atomic transfer over time. In this process, the LSPR of the synthesized Au nanoplate steadily was blue-shifted to 750 nm and the rounded Au nanodisk was synthesized.

### Synthesis of Au-Core Pt-Shell Nanodisk

The edge-selective Pt shell growth on the rounded Au nanodisk was carried out in a 50 mL round bottom flask at 70° C. 125 μL of 2.5 mM NaI, 4 mL of the synthesized rounded Au nanodisk, and 20 μL of 1 mM AgNO₃ were added to 20 ml of 50 mM CTAB solution. After the solution was preheated for 10 mm in a water bath at 70° C., 480 μL of 100 mM ascorbic acid was added to the solution. The solution was stirred at 500 rpm for one hour. 480 μL of 100 mM HCl and 50 μL of 1 mM H₂PtCl₆ were added sequentially using an injection interval of 30 seconds. The reaction was carried out in a 70° C. water bath with stirring at 500 rpm for 3.5 hours, and the reaction mixture was centrifuged twice with DIW (3000 g, 15 min) and redistributed into 1 mL of DIW.

### Synthesis and Selective Modification of Pt Split Nanoring

The edge-selective Pt-shell growth of the prepared Au-core Pt-shell nanodisk and Au-core Pt-shell nanodisk was carried out, and then the modification by the PEG molecule was performed.

The modification of the PEG molecule to the nanoparticles was performed in a 1.5 mL Eppendorf tube. 10 μL of 10 mM PEG methylether thiol (1 kDa) was added to 1 mL of the synthesized Au-core Pt-shell quasi-nanodisk and the solution was gently shaken overnight using an orbital shaker at room temperature. Half of the solution was transferred to another Eppendorf tube and 500 μL of 1 mM CTAB was added to each tube. The mixture was centrifuged twice with 1 mM CTAB (2000 g, 15 min) and redistributed into 500 μL of DIW to obtain the outer surface-protected Au-core Pt-shell nanodisk.

To synthesize the Pt split nanoring, 1040 μL of DIW, 500 μL of 100 mM CTAB solution, 5 μL of 10 mM NaI, and 500 μL of the outer surface-protected Au-core Pt-shell nanodisk (PEG-modified) were mixed in a 10 mL glass bottle. After the solution was preheated at 50° C. for 10 minutes, Au etching was started and 5 μL of 20 mM HAuCl₄ was injected. The solution was stirred at 500 rpm for three minutes. The color of the solution disappeared as the plasmonic Au portion dissolved into colorless Au(I) species. The solution was immediately centrifuged twice with DIW (7000 g, 10 min) at 16° C. and redistributed into 1 mL of 1% SDS solution. In addition, the positive charge of CTAB on the Au surface was decreased by further centrifugation with 1% SDS three times and 0.01% SDS (7000 g, 10 min) once. The final pellet was redistributed into 500 μL of 0.01% SDS.

250 μL of the synthesized Pt split nanoring solution was mixed with 2.5 μL of 10 mM PEG 2-mercaptoethyl ether acetic acid (2 kDa). 2.5 μL of 10 mM PEG 2-mercaptoethyl ether ethylamine (2 kDa) was added to another 250 μL of Pt split nanoring. Both of the mixed solutions were gently stirred overnight using an orbital shaker at room temperature. After one day, the two solutions were centrifuged twice with 0.1% SDS and once more with 0.01% SDS (7000 g, 15 min). Each pellet was redistributed into 10 μL of DIW.

### Synthesis of Au Nanocatenane

The EDC/sulfo-NHS coupling between the selectively modified Pt split nanorings was performed in a 1.5 mL Eppendorf tube. 10 μL of 1 mM EDC (in pH 5.5 100 mM MES buffer), 10 μL of 1 mM sulfo-NHS (in pH 5.5 100 mM MES buffer), and 10 μL of amine PEG-modified Pt-split nanoring were added sequentially to the solution of carboxyl PEG-modified Pt-split nanoring (dispersed in 10 μL of DIW) and stirred for 2 hours. Then, it was centrifuged twice with 0.1% SDS solution (7000 g, 10 min) and redistributed into 500 μL of DIW.

For the final Au growth and ring closure steps, 125 μL of the pre-interlocked Pt split nanorings solution was mixed with 250 μL of 1% PVP solution and a constant volume of DIW adjusting the total volume of the reaction mixture to 500 μL. To grow Au on the Pt framework, 10 mM hydroxylamine and 2 mM HAuCl₄ were added in equal volumes to the solution. In this case, the solutions with various volumes from 5 μL to 20 μL were used to obtain the nanocatenane structured bodies with different thicknesses (minor diameter). After the solution was gently stirred for two hours at room temperature, the solution was centrifuged twice with 0.01% SDS (2000 g, 10 min) and redistributed into 100 μL of DIW for subsequent measurements and PNIPAM modification.

### Light-Induced Thermal Operation of PNIPAM-Modified Au Nanocatenane

30 μL of Au nanocatenane solution was mixed with 3 μL of 1 mM PNIPAM-NH₂ (5.5 kDa) and gently stirred at room temperature overnight. Then, 1 μL of the solution was diluted with 19 μL of DIW and drop-cast onto the ITO substrate for optical characterization. After a while, the ITO substrate was cleaned with DIW to remove excess PNIPAM on the substrate and then dried by blowing with N₂ gas. Before measuring the scattering spectra, the position of the PNIPAM-modified Au nanocatenane on the ITO substrate was inspected using SEM (Hitachi S-4300 at 15 kV), which was carried out carefully to avoid damage to the PNIPAM by the electron beam. The sample was immersed in 20 μL of 50 mM NaCl solution along with an image spacer (13 mm diameter, 0.12 mm depth) and a glass cover slip.

The PNIPAM-modified Au nanocatenane was operated with a focus laser (473 nm, Cobolt Blues). The optical response was collected using the same dark-field illumination system as the single-particle scattering measurement. The scattering spectra of unpolarized, LCP, and RCP rays were further processed through Savitzky-Golay filtering after the correction for the background and lamp. The peak wavelength was extracted from the smooth signal.

While the present invention has been described with reference to the exemplary embodiments of the present invention in the above, it may be understood, by those skilled in the art or those of ordinary skill in the art, that the present invention may be variously modified and changed without departing from the spirit and scope of the present invention disclosed in the claims.

Accordingly, the technical scope of the present invention should not be limited to the contents disclosed in the detailed description of the specification but should be defined only by the claims.

1. A nanocatenane structured body comprising:
at least two interlocked ring structured bodies,
wherein the ring structured body comprises:
a core; and
a shell configured to cover the core, and
wherein the interlocked ring structured bodies are chemically bonded at a joining region.

2. The nanocatenane structured body of claim 1, wherein the core comprises a metal or semiconductor material.

3. The nanocatenane structured body of claim 1, wherein at least some regions of a ring inner surface of the ring structured body are modified with at least one of DNA, a protein, or a ligand, and
wherein a joining region of the interlocked ring structured body is provided with a cross-linking molecule generated by the binding of at least one of the DNA, protein, or ligand.

4. The nanocatenane structured body of claim 3, wherein a ring outer surface of the ring structured body has a structure modified with a compound comprising a thiol group.

5. The nanocatenane structured body of claim 1, wherein the ring structured bodies have an interlocked structure with the ring structured bodies spaced apart from each other by a distance of 20 to 100 nm.

6. The nanocatenane structured body of claim 1, wherein the ring structured bodies are interlocked with each other in a tilted form.

7. A method of synthesizing a nanocatenane structured body, the method comprising:
a first step of preparing a core;
a second step of preparing a modified core by modifying the core with at least one of DNA, a protein, and a ligand;
a third step of reacting at least two of the modified cores to be interlocked; and
a fourth step of growing a metal or a semiconductor on the interlocked core to close a missing region of the modified core.

8. The method of claim 7, wherein the first step comprises:
step 1-1 of preparing a nanoplate;
step 1-2 of growing the core along an edge of the nanoplate; and
step 1-3 of preparing the core by etching the nanoplate.

9. The method of claim 8, wherein a surface of the core is modified with a compound comprising a thiol group between step 1-2 and step 1-3.

10. The method of claim 7, wherein the third step comprises forming a chemical bond by reacting at least one of DNA, a protein, or a ligand provided on a ring outer surface of the modified core.

11. A nanomachine comprising a nanocatenane structured body, wherein the nanocatenane structured body converts a linear force into a rotational mechanical motion by a light-induced thermal operation,
wherein the nanocatenane structured body comprises at least two interlocked ring structured bodies,
wherein the ring structured body comprises a core and a shell configured to cover the core, and
wherein the interlocked ring structured bodies are chemically bonded at a joining region.

12. The nanomachine of claim 11, wherein the nanocatenane structured body controls a circular dichroism (CD) of a nanostructure.
